(19) United States
(12) Patent Application Publication
(10) Pub. No.: US 2014/0078626 A1
(43) Pub. Date: Mar. 20, 2014

(54) PROTECTION CIRCUIT

(71) Applicant: Gijs de Raad, Bemmel (NL)

(72) Inventor: Gijs de Raad, Bemmel (NL)

(73) Assignee: NXP B.V., Eindhoven (NL)

(21) Appl. No.: 13/620,186

(22) Filed: Sep. 14, 2012

(51) Int. Cl. H02H 9/04

(52) U.S. Cl. 361/56

(57) ABSTRACT

Conditions such as overvoltage/overcurrent (e.g., electrostatic discharge (ESD)) are addressed via a current-shunting approach. As may be consistent with one or more embodiments, an apparatus includes a transistor that couples an output signal, and a thyristor-based shunt circuit having a p-type anode connected to an n-type base including a highly-doped region that forms a drain of the transistor, a p-type base connected to the n-type base and including a channel of the transistor, and an n-type cathode connected to the p-type base. A resistor is coupled to pass current presented at the p-type anode directly to the drain, and to forward-bias a p-n junction between the p-type anode and the n-type base in response to an overvoltage type condition, therein shunting current via the shunt circuit.

Many circuits are susceptible to electrical overstress as may relate to electrostatic discharge (ESD) or other overvoltage or overcurrent conditions that can be damaging. To address such overstress, protection circuits that generally operate like a switch are used to bypass/shunt current during an electrical overstress condition. In the case of an electrical overstress, such protection circuits switch to a low ohmic state, to connect an input (or other circuit) to a reference terminal such as a ground, common or lower-level power-rail terminal, thus shunting excessive charge to a place where it does not harm the IC.

Thyristor devices such as the silicon controlled rectifier (SCR) have been attractive as a protection device for a variety of applications. A common primary ESD protection device is the so-called “Low Voltage Triggered Silicon Controlled Rectifier,” or LVTSCR. This device is essentially a hybrid form of a grounded gate nmost (ggnmost) and a regular SCR, where the ggnmost is used to set the trigger voltage of the device. Such SCRs can take a high ESD-current density before failure (20-40 mA/μm), which results in a small device footprint if a given ESD robustness is required, and also in a low pin capacitance. Theoretically, it is possible to drive the gate of the nmost in the LVTSCR to produce an output signal. However, such LVTSCRs have exhibited high series resistance, and other implementation challenges. These and other matters have presented challenges to the implementation of SCRs and other circuit components with protection circuits, for a variety of applications.

Various example embodiments are directed to protection circuits and their implementation. According to an example embodiment, an apparatus includes a transistor, a thyristor having regions of alternating polarity including respective p-type anode and n-type cathode end portions separated by n-type and p-type base regions, and a resistor electrically connected between the drain of the transistor and the anode. The n-type base region is connected to the p-type anode region and the transistor's drain, and the p-type base region is connected to the n-type base region and the transistor's channel. The resistor is configured and arranged to forward bias a p-n junction between the p-type anode region and the n-type base region, in response to an electrostatic discharge condition (ESD) presented at the anode (or other overvoltage/overcurrent). In the forward-biased state, the thyristor shunts current between the anode and cathode.

Another example embodiment is directed to a self-protected output circuit having a signal-passing circuit including a transistor, a shunt circuit including a thyristor, and a resistor that switches the thyristor between current states. The transistor has source and drain regions and couples an output signal via the source and drain regions responsive to a signal presented to a gate of the transistor. The thyristor has contiguous, alternating regions of opposite polarity in a substrate with the source and drain, the alternating regions including a p-type anode connected to an n-type base including a highly-doped region that forms the drain, a p-type base connected to the n-type base and including a channel of the transistor between the source and drain, and an n-type cathode connected to the p-type base. The p-type anode has a heavily-doped p+ contact and a lesser-doped p-type region between the p+ contact and the n-type base, and the n-type cathode has a heavily-doped n+ contact and a lesser-doped n-type region between the n+ contact and the p-type base. The resistor electrically couples the drain and the p+ contact, and is responsive to a voltage presented at the p+ contact by switching the thyristor into high conductance state to shunt current between the p+ and n+ contacts, by forward biasing a p-n junction between the lesser-doped p-type region and the n-type base.

Another example embodiment is directed to an apparatus having a thyristor with regions of opposite polarity including an n-type cathode and a p-type anode separated by an n-type base region and a p-type base region. A cathode terminal is connected to the n-type cathode and the p-type base region, and an anode terminal is connected to the p-type anode. A gate communicates data by controlling a first one of the base regions respectively in high and low conductance states, to flow current between a second one of the base regions and one of the n-type cathode and p-type anode to which the first one of the base regions is connected. A resistor electrically connects the n-type base region and the anode terminal, with the resistor and thyristor being configured and arranged to forward bias a p-n junction between the p-type anode region and the n-type base region in response to an ESD condition (or other overvoltage condition) presented at the anode terminal, and the thyristor being responsive to the forward bias by shunting current between the anode terminal and the cathode terminal.

The above discussion/summary is not intended to describe each embodiment or every implementation of the present disclosure. The figures and detailed description that follow also exemplify various embodiments.

Various example embodiments may be more completely understood in consideration of the following detailed description in connection with the accompanying drawings, in which:

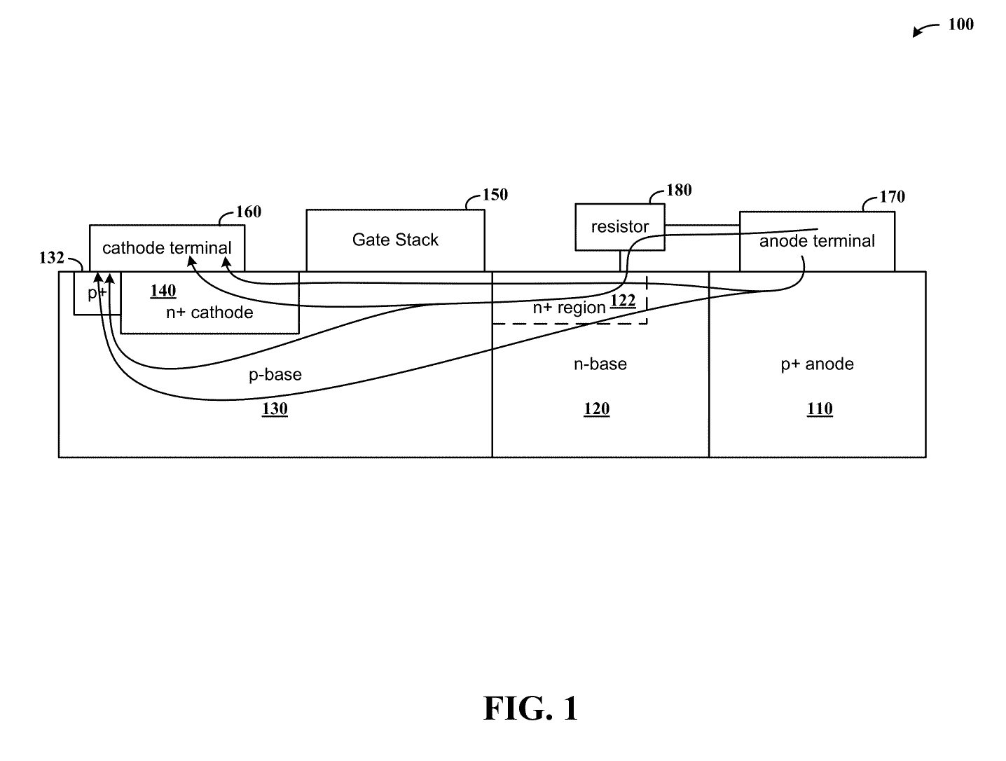

FIG. 1 shows a circuit protection apparatus, in accordance with one or more example embodiments;

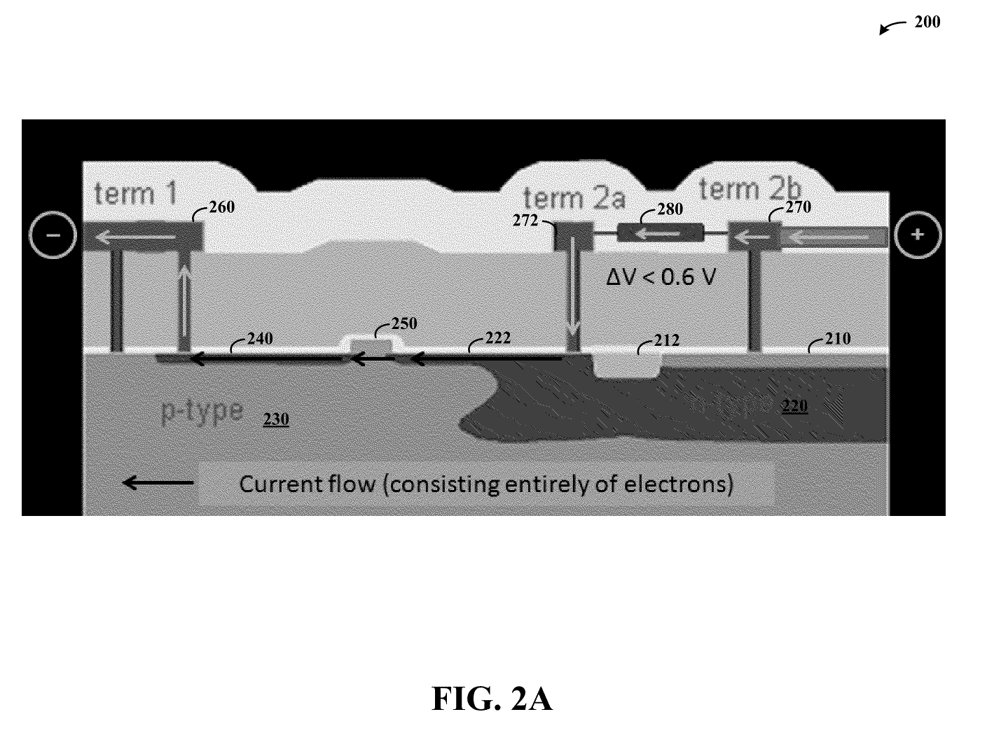

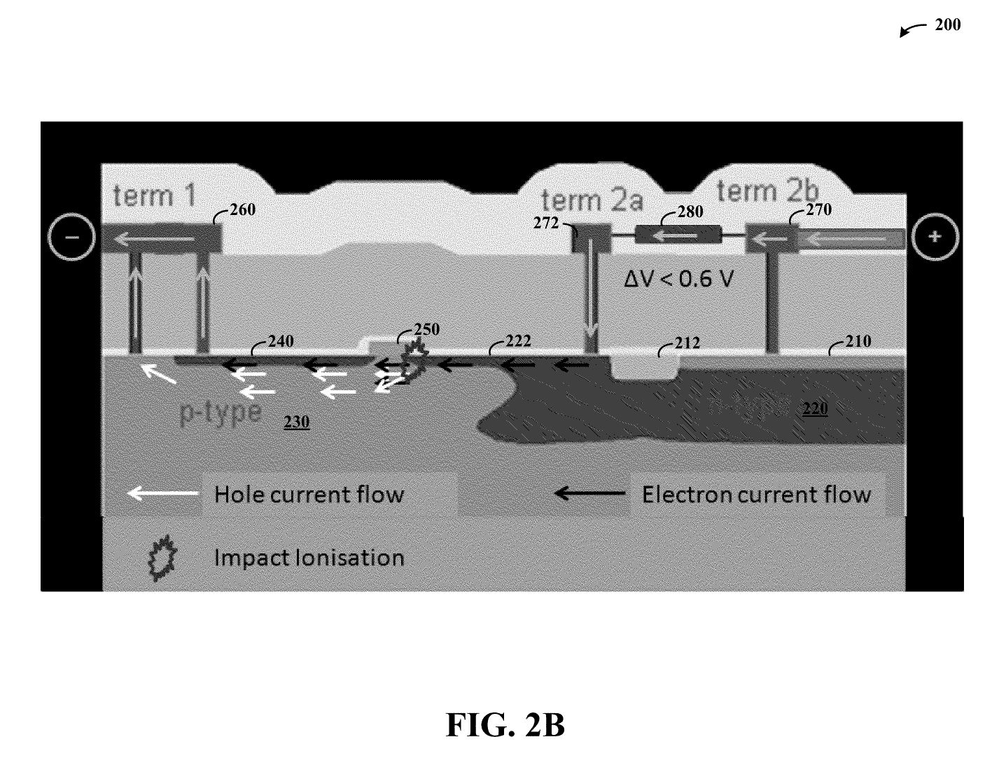

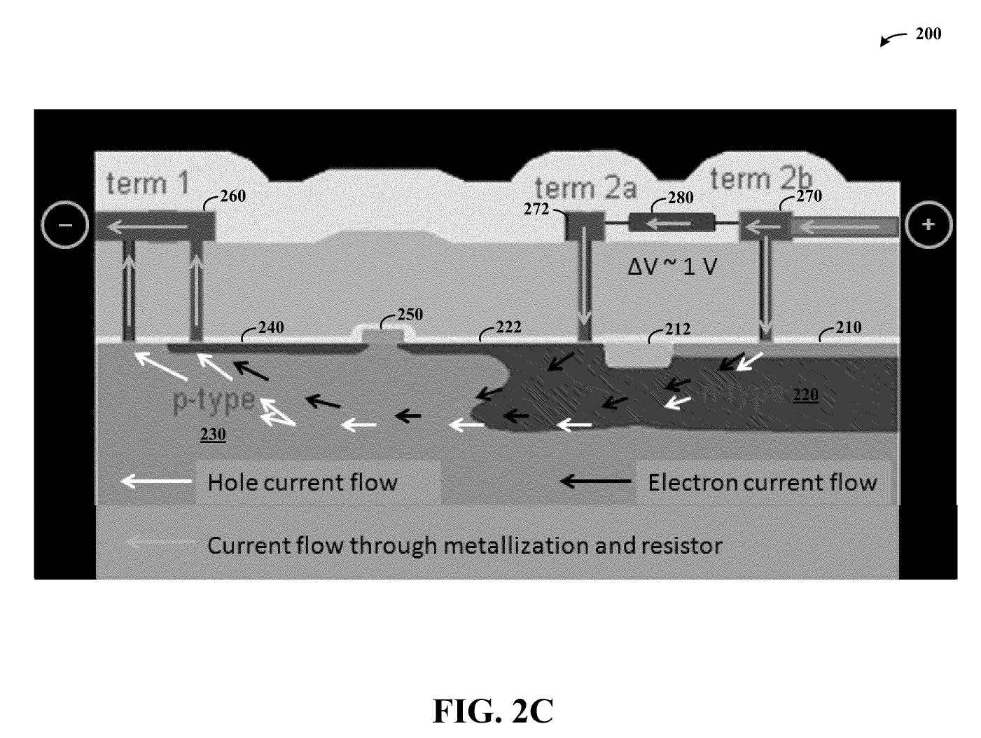

FIGS. 2A-2C show a protection circuit at various stages of operation, in accordance with one or more embodiments;

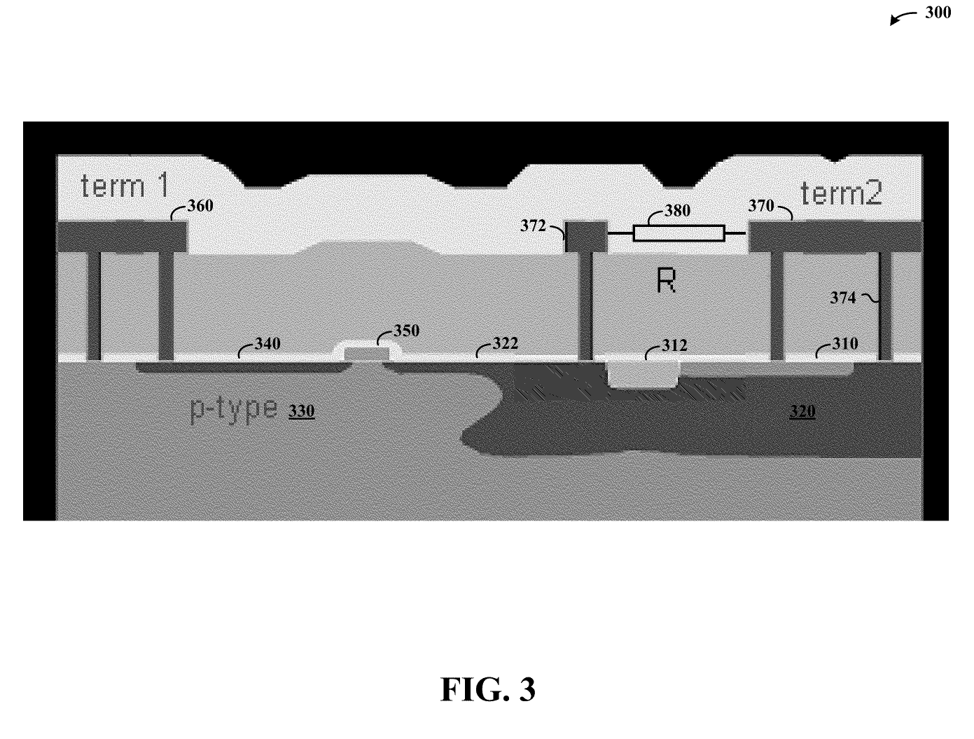

FIG. 3 shows a protection circuit with a dual-terminal anode, in accordance with another example embodiment;

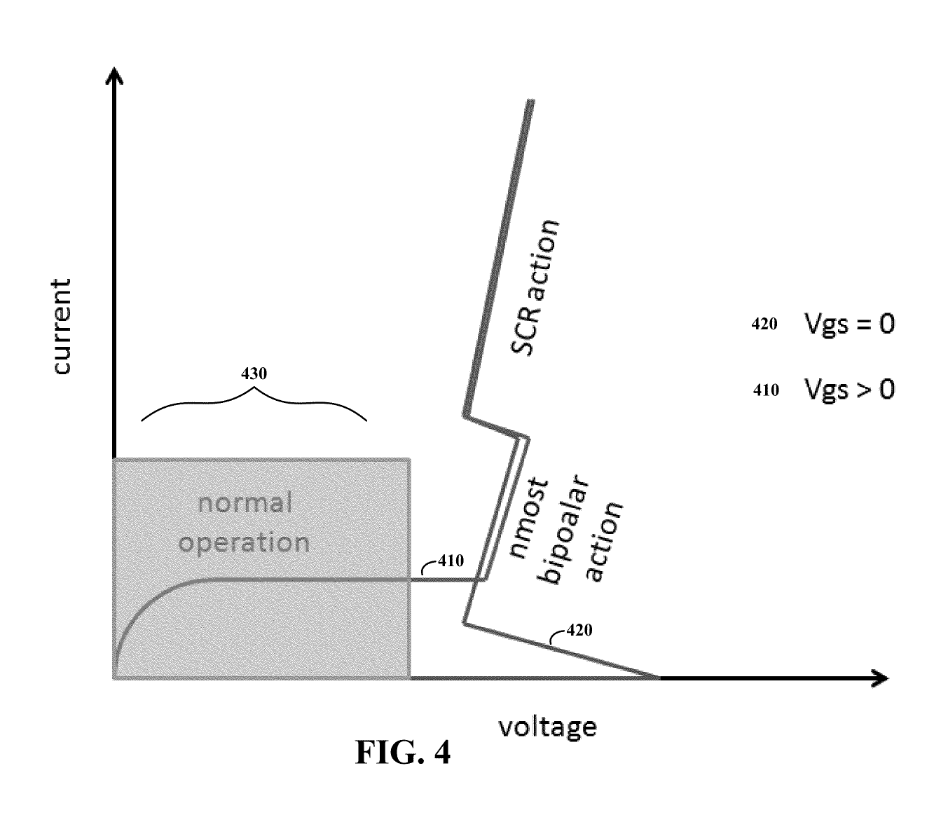

FIG. 4 shows a plot of current-voltage characteristics of a protection circuit, in accordance with another example embodiment of the present invention; and

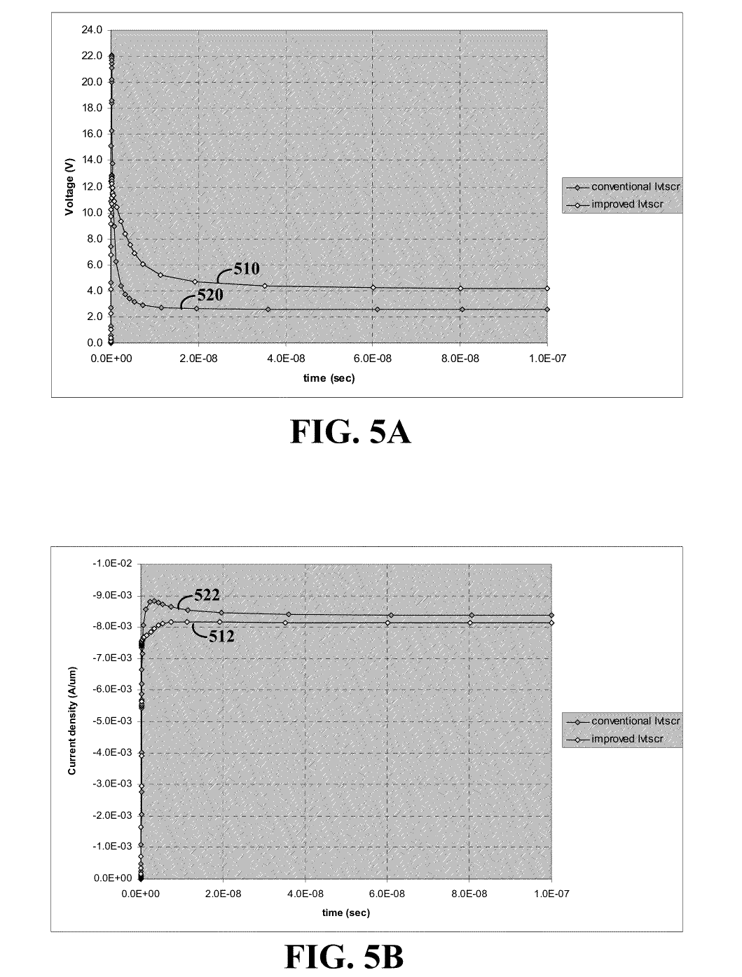

FIGS. 5A and 5B show pots of current density versus time for a protection device, in accordance with another example embodiment.

While various embodiments discussed herein are amenable to modifications and alternative forms, aspects thereof have been shown by way of example in the drawings and will be described in detail. It should be understood, however, that the intention is not to limit the invention to the particular embodiments described. On the contrary, the intention is to cover all modifications, equivalents, and alternatives falling within the scope of the disclosure including aspects defined in the claims. In addition, the term “example” as used throughout this application is only by way of illustration, and not limitation.

Aspects of the present disclosure are believed to be applicable to a variety of different types of apparatuses, systems and methods involving protection circuits. While not necessarily so limited, various aspects may be appreciated through a discussion of examples using this context.

Various example embodiments are directed to a protection circuit that addresses conditions such as overvoltage/overcurrent conditions, and those referred to as electrostatic discharge (ESD) conditions. Certain embodiments are directed to a self-protected output circuit, in which an nmost inside the LVTSCR operates as a signal output device. In some implementations, an n-well connection is made in a LVTSCR with a connectivity including an explicit resistor that forward-biases an anode-base junction of the thyristor that facilitates such protection. With these approaches, robust ESD protection can be provided in a compact device. These and other embodiments address challenges, including those discussed in the above background discussion.

The resistor value and corresponding forward-biasing aspects can be tuned to suit particular applications. The resistor value is sufficiently large enough to forward-bias a p-plus/n-well junction (thyristor anode/n-base) during an ESD-strike, yet is low enough to allow the use of the nmost as an output device. In some implementations, the resistor value is about one order of magnitude lower than an inherent n-well resistor that is incorporated in the thyristor, to address ESD-strike conditions in which the current density inside a device is at least an order of magnitude larger than the current density during normal circuit operation. Using this approach, small nmost-based outputs can be made self-protecting against ESD-strikes, such as to render a 100 μm nmost robust protection against a 4 kV human body-model (HBM) strike.

In a more particular embodiment, ESD-type strikes are shunted between anode and cathode terminals via a thyristor, as controlled by a resistor that couples across and forward-biases a p-n junction between the anode and a corresponding n-base region of the thyristor. The device also includes a transistor having source and drain regions that are heavily-doped portions of an n-base and n+ cathode of the thyristor, and a channel in a p-base region of the thyristor between the source and drain. In some implementations the transistor operates to couple an output signal, and in certain embodiments has its gate coupled to the cathode terminal.

The transistor operates in a non-ESD mode to conduct current between the source and the anode terminal, via the resistor, at a voltage level that is below a voltage level at which the resistor forward-biases the p-n junction (e.g., under conditions in which the transistor operates to output a signal). The transistor operates responsive to an onset of the ESD condition, to conduct current between the anode and cathode terminals via the resistor, prior to the p-n junction becoming forward-biased, by flowing electron current to the cathode via the source and flowing hole current, generated via impact ionization at a p-n junction between the drain and p-type base region, to the cathode via the p-type base region, bypassing the source and channel. In response to the p-n junction becoming forward-biased, the thyristor shunts electron and hole current via thyristor operation of the p-type anode, n-type base region, p-type base region and n-type cathode while bypassing current flow via the channel region and the drain.

A more particular example embodiment is directed to a self-protected output circuit having a signal-passing circuit, a shunt circuit and a resistor that operates to couple a voltage to the signal-passing circuit and to operate the shunt circuit in a shunt condition in response to an overvoltage condition. The signal-passing circuit includes a transistor with source and drain regions in a substrate, the drain being coupled to the resistor, and via which an output signal is passed responsive to a signal presented to a gate of the transistor. The shunt circuit includes a thyristor having contiguous, alternating regions of opposite polarity, which are also in the substrate and include a p-type anode connected to an n-type base, a p-type base connected to the n-type base, and an n-type cathode connected to the p-type base. The p-type anode has a heavily-doped p+ contact and a lesser-doped p-type region between the p+ contact and the n-type base. The n-type cathode has a heavily-doped n+ contact and a lesser-doped n-type region between the n+ contact and the p-type base. The n-type base includes a highly-doped region that forms the drain, and the p-type base includes a channel via which the transistor passes current. The resistor switches the thyristor into a high conductance state in response to a high voltage at the p-type anode by forward-biasing a p-n junction between the lesser-doped p-type region and the n-type base.

The self-protected output circuit operates in a communication mode to conduct current between the resistor and the source via the drain and channel, at a voltage level that is below a threshold voltage level at which the resistor forward-biases the p-n junction. The self-protected output circuit also operates in an higher voltage/overvoltage onset mode, prior to the p-n junction being forward-biased, by conducting electron current between the resistor and the source via the drain and channel, and by conducting hole current between the resistor and the p+ contact via the drain and p-type base while bypassing the channel. In a very high overvoltage mode, the self-protected output circuit operates responsive to the p-n junction becoming a forward-biased, shunt hole current between the p+ and n+ contacts via the p-type anode, n-type base region and p-type base region, and shunt electron current between the n+ contact and each of the resistor and the p+ contact via the n-type base and p-type base.

Turning now to the figures, FIG. 1 shows a circuit protection apparatus 100, in accordance with one or more example embodiments. The apparatus 100 includes a thyristor including a p+ anode region 110, an n-type base region 120 connected to the p-type anode region, a p-type base region 130 connected to the n-type base region, and an n+ cathode region 140 connected to the p-type base region. A transistor includes a gate stack 150 located adjacent the p-base 130, which forms a channel of the transistor between source and drain regions respectively implemented with the n+ cathode 140 and n-type base 120 (or, in some instances, with a heavily-doped n+ region 122, with n-type base 120 being an extended drain portion of 122). A cathode terminal 160 is connected to the n+ cathode 140 and the p-base region 130 (in some embodiments, via a p+ region 132 that enhances contact). An anode terminal 170 is connected to the p+ anode 110. A resistor 180 is electrically connected between the drain of the transistor (122/120) and the anode terminal 170, and configured and arranged to forward-bias a p-n junction between the p+ anode 110 and the n-type base region 120, in response to an electrostatic discharge condition (ESD) presented at the anode terminal. In the forward-biased state, the apparatus 100 shunts current between the anode and cathode terminals 160 and 170.

Prior to the p-n junction between the p+ anode 110 and the n-type base 120 becoming forward-biased, the apparatus 100 operates to conduct current between the anode and cathode terminals 160/170 via the resistor 180. Such operation may be, for example, responsive to the onset of an ESD condition, during onset but before the forward-bias has been effected, or during normal operation (e.g., voltage across the resistor is insufficient to facilitate forward-biasing). In some embodiments, the apparatus 100 operates in such a state which the p-n junction is not forward-biased, to couple signals presented to the gate 150 by biasing the p-type base region 130 between the n+ cathode 140 and the n+ region 122 of the n-base 120, and conducting current via the resistor 180.

As discussed above, the apparatus 100 operates under different conditions to pass or shunt current, via one or more regions therein. In a more particular embodiment, the apparatus 100 operates in three modes. In a first mode (e.g., normal or non-ESD type of operation), the apparatus 100 conducts current between the source 140 and anode terminal 170, via the resistor 180, at a voltage level that is below a voltage level at which the resistor forward-biases the p-n junction. The apparatus 100 is responsive to an onset of the ESD condition in a second mode, to conduct current between the anode and cathode terminals 160/170 via the resistor 180, prior to the p-n junction becoming forward-biased, by flowing electron current to the cathode via the source 140 and by flowing hole current, generated via impact ionization at a p-n junction between the drain 122 and p-type base region 130, to the cathode terminal 160 via the p-type base region (bypassing the source and channel). In a third mode, the apparatus 100 operates in response to the p-n junction becoming forward-biased by shunting electron and hole current via thyristor operation of the p-type anode, n-type base region and p-type base region while bypassing current flow via the channel region (and, e.g., further bypassing the drain).

FIGS. 2A-2C show a protection circuit 200 at various stages of operation, in accordance with another example embodiment. The apparatus 200 includes a p+ anode region 210, an n-type base region 220, a p-type base region 230, and an n+ cathode region 240. A gate stack 250 is located adjacent the p-base 230, which forms a channel between the n+ cathode 240 (source) and region 222 of n-type base 220 (e.g., with region 222 being heavily doped, relative to the rest of the n-type base, and laterally separated from the p+ anode by an insulating spacer 212). A cathode terminal 260 is connected to the n+ cathode 240 and the p-base region 230, and further to ground or a reference voltage. In some embodiments, a portion of the p-base region 230 in contact with the cathode terminal 260 is heavily p-doped to facilitate contact with the terminal. An anode terminal 270 is connected to the p+ anode 210, and to a drain terminal via a resistor 280 that forward-biases a p-n junction between the p+ anode 210 and the n-type base region 220, in response to an electrostatic discharge condition (ESD) presented at the anode terminal.

Beginning with FIG. 2A, internal current flow is shown during normal (i.e., non-ESD) circuit operation, in which the device acts as a regular nmost flowing current between the anode and cathode terminals 260 and 270 via the resistor 280 and source/drain regions 240 and 222, via a channel in p-base 230, in response to a voltage on the gate 250.

In FIG. 2B, internal current flow is shown during a low-intensity ESD-strike and/or during onset of a high-intensity ESD-strike. Under these conditions, the device 200 acts as a self-protecting nmost output device, in which a signal input via the gate 250 is passed under protected conditions in which excess current flowing via the resistor 280 is passed via hole current (generated by impact ionization) through the p-base region 230, as well as by electron current that flows through the p-base region 230 to the cathode region 240. This electron current is a result of the forward-bias of the p-n junction between the cathode region 240 and the p-base region 230 that is created by the hole current flowing through the p-base 230.

In FIG. 2C, internal current flow is shown during a high-intensity ESD-strike, in which the device acts to shunt current (e.g., as an SCR). Under these conditions, the voltage at anode terminal 270 is high enough to forward-bias the p-n junction between the p+ anode 210 and n-type base 220, via the resistor 280. This forward-bias switches the corresponding thyristor/SCR into a current-passing state in which both electron and hole current flows as shown between the cathode and anode terminals 260 and 270, via regions 210, 220 and 230 to the cathode terminal 260 (both directly and via n+ cathode 240). In this forward-biased condition, some current also flows via resistor 280, terminal 272 and the n-type base 220, p-type base 230 and n+ cathode 240. Under these high-intensity ESD conditions, the channel between the source/drain regions 240 and 222 is bypassed.

The current at which the device crosses over from the second to the third regime of operation exemplified in FIGS. 2B and 2C is set by the resistance of the resistor 280, and can thus be tuned to suit particular applications. In some implementations, the resistor 280 has a resistance value that is about an order of magnitude lower than a resistance of a portion of the n-type base region 220 between the p+ anode 310 and the p-type base 230. Further, this resistance can facilitate operation of the device 200 under low resistance values (e.g., lower than that of internal resistance required to switch a thyristor/SCR into a conducting state), which permits use of the device as an output circuit.

FIG. 3 shows a protection circuit 300 with a dual-terminal anode, in accordance with another example embodiment. The circuit 300 is similar to the circuit 200 shown in FIGS. 2A-2C, with similar regions labeled similarly (e.g., resistor 380 is labeled similarly to resistor 280). The circuit 300 includes an additional contact 374 between anode terminal 370 and n-type base 310 (n-well).

FIG. 4 shows a plot of current-voltage characteristics of a protection circuit, in accordance with another example embodiment of the present invention. Plot 410 shows current-voltage (I(V)) behavior for a closed gate device, and plot 420 shows such behavior for an open gate device (e.g., gate grounded). A normal operation regime 430 refers to operation as a signal output. Bipolar and SCR (current-shunting) regions occur as shown, with bipolar operation effected via impact ionization prior to forward-biasing of a p-n junction between a p+ anode and an n-well, the impact ionization occurring (e.g., as shown in FIG. 2B) in an n+ (drain) region of the n-well.

FIGS. 5A and 5B show voltage and current plots of the operation of a protection device, in accordance with another example embodiment. Plots 510 and 512 respectively show voltage and current operation of an LVTSCR-based output subjected to a 100 ns TLP-like pulse (50 V pulse delivered through a 50 Ohms series resistance), with a 200 picosecond rise time. Plots 520 and 522 show such operation for a LVTSCR without a resistor and related forward-biasing characteristics. For example, during the initial phase of the ESD-strike, the nmost conducts most of the ESD-current as any SCR has a turn on time in the order of several nanoseconds. As long as the ESD-current flow during the nmost is limited to a few nanoseconds, this can be effected without harming the robustness of the device, and the fail current density of this LVTSCR-based output should approach that of a regular LVTSCR. Further, transient voltage overshoot that many SCRs have is avoided, as is shown in FIGS. 5A and 5B.

Based upon the above discussion and illustrations, those skilled in the art will readily recognize that various modifications and changes may be made to the various embodiments without strictly following the exemplary embodiments and applications illustrated and described herein. For example, differently-doped regions can be implemented to effect current flow as described herein, and circuits implemented for signal-passing can be effected as protection circuits (e.g., without signal-passing and/or connecting the transistor gate to a cathode terminal). Such modifications do not depart from the true spirit and scope of various aspects of the invention, including aspects set forth in the claims.

What is claimed is:

1. An apparatus comprising:
an anode terminal;
a cathode terminal;
a transistor having a source, drain, gate, and channel region between the source and drain;
a thyristor including a p-type anode region connected to the anode terminal, an n-type base region connected to the p-type anode region and the drain, a p-type base region connected to the n-type base region and the channel, and an n-type cathode region connected to the p-type base region and the cathode terminal; and
a resistor electrically connected between the drain of the transistor and the anode terminal, and configured and arranged to forward-bias a p-n junction between the p-type anode region and the n-type base region in response to an electrostatic discharge condition (ESD) presented at the anode, the thyristor being responsive to the forward-bias by shunting current between the anode and cathode.

2. The apparatus of claim 1, wherein the transistor is configured and arranged to, in response to an onset of the ESD condition, operate to conduct current between the anode and cathode terminals via the resistor, prior to the p-n junction between the p-type anode region and n-type base region being forward-biased.

3. The apparatus of claim 1, wherein the transistor is configured and arranged to conduct current between the anode and cathode terminals via the resistor in response to a voltage at the anode that is insufficient to cause the p-n junction between the p-type anode region and n-type base region to switch to a forward-biased state.

4. The apparatus of claim 1, wherein the gate is coupled to a signal line and configured and arranged to operate responsive to the signal by biasing the p-type base region and conducting current between the source and the anode terminal, via the resistor, at a voltage level that is below a voltage level at which the resistor forward-biases the p-n junction between the p-type anode region and n-type base region.

5. The apparatus of claim 1, wherein the resistor has a resistance value that is about an order of magnitude lower than a resistance of the n-type base region between the p-type anode region and the p-type base region.

6. The apparatus of claim 1, wherein the n-type base region is connected directly to the anode terminal and to the anode terminal via the drain.

7. The apparatus of claim 1, wherein
the drain has a higher concentration of n-doping, relative to the n-type base region, and
the n-type base region is connected directly to the anode terminal via a conductor, and to the anode terminal via the drain.

8. The apparatus of claim 1, wherein the n-type base region is an extended drain region of the transistor drain, the extended drain region being contiguous with the drain and having an n-doping concentration that is lower than an n-doping concentration of the drain, the extended drain being configured and arranged to switch drain voltages that are significantly higher than a maximum gate voltage that the transistor is configured and arranged to operate under.

9. The apparatus of claim 1, wherein the p-type base region is coupled to the cathode terminal and configured and arranged to pass current between the n-type base and the cathode terminal while bypassing current flow through the channel, in response to the ESD condition.

10. The apparatus of claim 1, wherein
the transistor is configured and arranged to operate in a non-ESD mode to conduct current between the source and the anode terminal, via the resistor, at a voltage level that is below a voltage level at which the resistor forward-biases the p-n junction between the p-type anode region and n-type base region,
the transistor is configured and arranged to operate, in response to an onset of the ESD condition, to conduct current between the anode and cathode terminals via the resistor, prior to the p-n junction between the p-type anode region and n-type base region becoming forward-biased, by flowing flow electron current to the cathode via the source and by flowing hole current, generated via impact ionization at a p-n junction between the drain and p-type base region, to the cathode via the p-type base region and bypassing the source and channel, and
in response to the p-n junction between the p-type anode region and n-type base region becoming forward-biased, the thyristor shunts electron and hole current via thyristor operation of the p-type anode, n-type base region and p-type base region while bypassing current flow via the channel region and the drain.

11. The apparatus of claim 1, wherein
the p-type base region includes a p+ contact region connected to the cathode and having a p-dopant concentration that is higher than a p-dopant concentration of the rest of the p-type base region, and
the n-type base region includes an n+ region having an n-doping concentration that is higher than the n-doping concentration of the rest of the n-type base region, and the drain includes the n+ region.

12. A self-protected output circuit comprising:
a signal-passing circuit including a transistor having source and drain regions in a substrate and being configured and arranged to couple an output signal via the source and drain regions responsive to a signal presented to a gate of the transistor;
a shunt circuit including a thyristor having contiguous, alternating regions of opposite polarity in the substrate including a p-type anode connected to an n-type base having a highly-doped region that forms the drain, a p-type base connected to the n-type base and having a channel of the transistor between the source and drain, and an n-type cathode connected to the p-type base, the p-type anode having a heavily-doped p+ contact and a lesser-doped p-type region between the p+ contact and the n-type base, the n-type cathode having a heavily-doped n+ contact and a lesser-doped n-type region between the n+ contact and the p-type base;
a resistor electrically coupled to the drain and the p+ contact and configured and arranged to, in response to a voltage presented at the p+ contact, switch the thyristor into high conductance state and shunt current between the p+ and n+ contacts by forward-biasing a p-n junction between the lesser-doped p-type region and the n-type base.

13. The circuit of claim 12, wherein the signal-passing circuit is configured and arranged to couple the output signal by coupling respective anode and cathode terminals that are connected to the p+ and n+ contacts, via the resistor, drain, channel and source.

14. The circuit of claim 12, wherein the signal-passing circuit is configured and arranged to
operate in a communication mode to conduct current between the resistor and the source via the drain and channel, at a voltage level that is below a threshold voltage level at which the resistor forward-biases the p-n junction, and
operate in an overvoltage onset mode, prior to the p-n junction being forward-biased, by conducting hole current between the resistor and the p+ contact via the drain and p-type base while bypassing the channel, via impact ionization at a p-n junction between the drain and p-type base, and using the hole current to forward-bias a p-n junction between the p-type base and the n-type cathode and conduct electron current between the resistor and the source.

15. The circuit of claim 14, wherein the shunt circuit is configured and arranged to, in an overvoltage mode and in response to the p-n junction becoming forward-biased, bypass current flow via the drain and channel, shunt hole current between the p+ and n+ contacts via the p-type anode, n-type base region and p-type base region, and shunt electron current between the n+ contact and each of the resistor and the p+ contact via the n-type base and p-type base.

16. An apparatus comprising:
a thyristor having regions of opposite polarity including an n-type cathode and a p-type anode separated by an n-type base region and a p-type base region;
a cathode terminal connected to the n-type cathode and the p-type base region;
an anode terminal connected to the p-type anode;
a gate configured and arranged to communicate data by controlling a first one of the base regions respectively in high and low conductance states, to flow current between a second one of the base regions and one of the n-type cathode and p-type anode to which the first one of the base regions is connected; and
a resistor electrically connected between the n-type base region and the anode terminal, the resistor and thyristor being configured and arranged to forward-bias a p-n junction between the p-type anode region and the n-type base region in response to an electrostatic discharge (ESD) condition presented at the anode terminal, the thyristor being responsive to the forward bias by shunting current between the anode terminal and the cathode terminal.

17. The apparatus of claim 16, wherein
the n-type base region includes a highly-doped n+ region immediately adjacent a channel portion of the p-type base region below the gate,
the gate, channel portion, n+ region and p-type anode forming a transistor configured and arranged to pass current between the anode terminal and the cathode terminal via the resistor, when the p-n junction between the p-type anode region and the n-type base region is not forward-biased.

18. The apparatus of claim 16, wherein the thyristor and the resistor are configured and arranged to, in response to an ESD condition presented at the anode terminal,
prior to the p-n junction between the p-type anode region and the n-type base region becoming forward-biased, shunt current between the anode terminal and the cathode terminal via the resistor, n-type base region, p-type base region and n-type cathode, and
in response to the p-n junction between the p-type anode region and the n-type base region becoming forward-biased, shunt current between the anode terminal and the cathode terminal via the p-type anode, n-type base region and p-type base region.

19. The apparatus of claim 18, wherein
prior to the p-n junction between the p-type anode region and the n-type base region becoming forward-biased, the gate, channel portion, n+ region and p-type anode are configured and arranged to conduct current in a bipolar mode of transistor operation via impact ionization in the n+ region, and
in response to the p-n junction between the p-type anode region and the n-type base region becoming forward-biased, shunt the current via thyristor operation of the p-type anode, n-type base region and p-type base region.

20. The apparatus of claim 16, wherein the gate is coupled to a signal line and configured and arranged to operate responsive to the signal by biasing the p-type base region and conducting current between the source terminal and the anode terminal, via the resistor, at an anode terminal voltage level that is below a voltage level at which the resistor forward-biases the p-n junction between the p-type anode region and the n-type base region.
